(19) United States
(12) Patent Application Publication
(10) Pub. No.: US 2017/0336190 A1
(43) Pub. Date: Nov. 23, 2017

(54) BEND SENSOR

(71) Applicant: NIPPON MEKTRON, LTD., Tokyo (JP)

(72) Inventors: Mikiya MATSUURA, Tsukuba-shi, Ibaraki (JP); Katsuei TAKAHASHI, Tsukuba-shi, Ibaraki (JP); Naoki CHIKUGO, Tsukuba-shi, Ibaraki (JP); Kazuhiko MAEKAWA, Tsukuba-shi, Ibaraki (JP); Kenji SHACHI, Tsukuba-shi, Ibaraki (JP)

(73) Assignee: NIPPON MEKTRON, LTD., Tokyo (JP)

(21) Appl. No.: 15/522,395

(22) PCT Filed: Nov. 2, 2015
(86) PCT No.: PCT/JP2015/080893

§ 371 Date: Apr. 27, 2017

(30) Foreign Application Priority Data
Nov. 5, 2014 (JP) 2014-225064

(51) Int. Cl. G01B 7/16; C08K 3/04; C08F 297/04; G01N 27/30; B01J 39/20

(52) U.S. Cl. CPC G01B 7/16; G01N 27/30; B01J 39/20; C08F 297/04; C08K 3/04

(57) ABSTRACT

A bend sensor comprising a sensor section in which a polymer electrolyte film is sandwiched between a pair of electrode films, wherein each of the electrode films contains: a block copolymer (Z) having a polymer block (S) composed of a structural unit derived from an aromatic vinyl compound, and containing an ion-conducting group, and an amorphous polymer block (T) composed of a structural unit derived from an unsaturated aliphatic hydrocarbon; and a conducting particle; which block copolymer (Z) forms a lamellar structure, which bend sensor therefore allows generation of enhanced voltage between the electrode films when deformation of the sensor occurs as it follows movement of an object, is provided.

### TECHNICAL FIELD

The present invention relates to a bend sensor. More specifically, the present invention relates to a bend sensor having a sensor section composed of a polymer electrolyte film sandwiched between a pair of electrode films, which sensor section detects movement of an object by voltage generated between the electrode films when the sensor section undergoes elastic deformation as it follows the movement of the object.

### BACKGROUND ART

Bend sensors which detect movement of an object by undergoing deformation as they follow the movement are used for measurement devices, controllers, and the like in the fields of industry, medicine, and the like.

For example, a bend sensor in which a spherical conductive filler is blended in an elastomer is known (see Patent Document 1). Such a bend sensor can detect movement of an object by a change in the electric resistance that occurs when the sensor undergoes elastic deformation as it follows the movement of the object. Such a bend sensor requires a power source for detection of the electric resistance.

On the other hand, bend sensors that do not require a power source are known. Examples of such sensors include a bend sensor having a sensor section in which a polymer electrolyte film is sandwiched between a pair of electrode films containing a polymer electrolyte and a conducting particle (see Patent Document 2). Such a bend sensor can detect movement of an object by voltage generated between the electrode films when the sensor section undergoes elastic deformation as it follows the movement of the object. Thus, since the sensor enables miniaturization, simplification, energy saving, and the like of devices, application of the sensor to a wide range of uses can be expected. However, from the viewpoint of, for example, increasing reliability of measured values, a further increase in the voltage generated has been demanded.

### PRIOR ART DOCUMENTS

### Patent Documents

Patent Document 1: JP 2008-070327 A

Patent Document 2: JP 2012-069416 A

### SUMMARY OF THE INVENTION

### Problems to be Solved by the Invention

An object of the present invention is to provide a bend sensor having a sensor section composed of a polymer electrolyte film sandwiched between a pair of electrode films containing a polymer electrolyte and a conducting particle, wherein a high voltage is generated between the electrode films when the sensor section undergoes elastic deformation as it follows movement of an object.

### Means for Solving the Problems

In order to solve the object described above, the present invention provides the following:

[1] a bend sensor comprising a sensor section in which a polymer electrolyte film is sandwiched between a pair of electrode films each containing:

a block copolymer (Z) having:
a polymer block (S) composed of a structural unit derived from an aromatic vinyl compound, and containing an ion-conducting group; and
an amorphous polymer block (T) composed of a structural unit derived from an unsaturated aliphatic hydrocarbon; and

a conducting particle;

and having a lamellar structure formed by a phase composed of the polymer block (S) and a phase composed of the polymer block (T);
[2] the bend sensor according to [1], wherein the width of the phase composed of the polymer block (S) forming the lamellar structure is within the range of 3 to 90 nm; and
[3] the bend sensor according to [1] or [2], wherein the block copolymer (Z) has a structure in which an ion-conducting group is introduced to a polymer block (S₀) of a block copolymer (Z₀) having:

a polymer block (S₀) composed of a structural unit derived from an aromatic vinyl compound, and containing no ion-conducting group; and

an amorphous polymer block (T) composed of a structural unit derived from an unsaturated aliphatic hydrocarbon;

wherein the mass ratio between the polymer block (S₀) and the polymer block (T) in the block copolymer (Z₀) is within the range of 40:60 to 90:10.

### Effect of the Invention

In the bend sensor of the present invention, the voltage generated between the electrode films when the sensor section undergoes elastic deformation as it follows movement of an object is high, so that the measured values are reliable.

### BRIEF DESCRIPTION OF THE DRAWINGS

FIG. 1 is a schematic diagram showing a lamellar structure in the pair of electrode films contained in the bend sensor of the present invention, which lamellar structure is formed by phases composed of a polymer block (S) and phases composed of a polymer block (T).

FIG. 2 is a schematic drawing showing an example of the cross-sectional structure of the bend sensor of the present invention.

FIG. 3 is a schematic drawing showing another example of the cross-sectional structure of the bend sensor of the present invention.

FIG. 4 is a transmission electron micrograph of a cross section along the thickness direction of an evaluation polymer electrolyte film prepared using a block copolymer (Z-1).

FIG. 5 is a transmission electron micrograph of a cross section along the thickness direction of an evaluation polymer electrolyte film prepared using a block copolymer (Z-2).

FIG. 6 is a drawing showing a method for evaluating the performance of the bend sensor of the present invention.

FIG. 7 is a voltage waveform diagram obtained from the bend sensor of Example 1.

FIG. 8 is a voltage waveform diagram obtained from the bend sensor of Comparative Example 1.

### MODE FOR CARRYING OUT THE INVENTION

As shown in FIG. 2, the bend sensor of the present invention has a sensor section in which a polymer electrolyte film 2 is sandwiched between a pair of electrode films, that is, an electrode film 3a and an electrode film 3b.

It is assumed that, when the sensor section undergoes elastic deformation, a difference in the ion density occurs between the electrode films, causing migration of ions from one electrode film to the other electrode film such that the difference in the ion density is resolved, and generating, as a result, a bias of electric charge between the electrode films, so that the voltage is generated.

### [Electrode Film]

The thickness of the electrode film used in the bend sensor of the present invention is preferably 1 μm to 10 mm, more preferably 5 μm to 1 mm, still more preferably 10 to 500 μm.

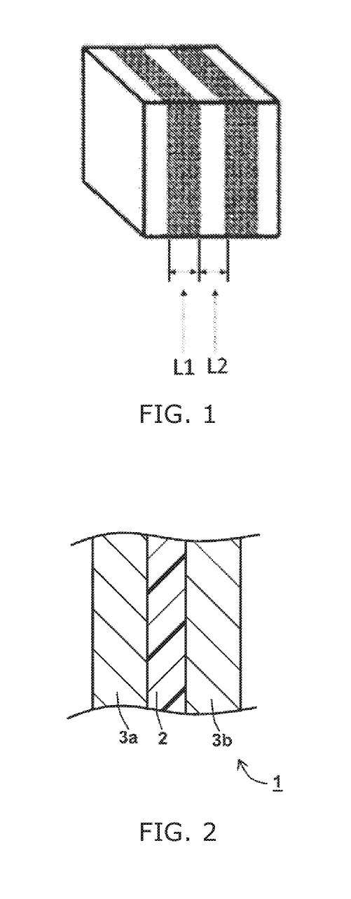

In such an electrode film, a polymer block (S) and a polymer block (T) show phase separation from each other, and a phase(s) composed of the polymer block (S) and a phase(s) composed of the polymer block (T) form a lamellar structure. The “lamellar structure” herein means a phase separation structure in which a plurality of phases are laminated on each other to form layers. As shown in FIG. 1, in the bend sensor of the present invention, a phase(s) formed by the polymer block (S) and a phase(s) formed by the polymer block (T) are laminated on each other to form layers.

The phase composed of the polymer block (S) plays a role as a migration path of ions, and the phase composed of the polymer block (T) plays a role in giving elasticity and flexibility to the sensor section. It is assumed that, by the formation of the lamellar structure, efficient migration of ions between the electrode films is possible when the sensor section of the bend sensor of the present invention undergoes elastic deformation, so that a high voltage can be generated. The lamellar structure may be formed in the entire electrode film, or may be partially formed therein. From the viewpoint of easy migration of ions between the electrode films, the phases composed of the polymer block (S) in the lamellar structures preferably communicate between the main surfaces of the electrode films. The above assumption can be commonly employed irrespective of the type of the monomers constituting the block copolymer (Z).

The lamellar structure in the electrode film contained in the bend sensor of the present invention can be observed using a transmission electron microscope (TEM). Since the electrode film contains a conducting particle, preparation of a sample (ultrathin section) for the TEM observation may be difficult in some cases. In such cases, since the presence or absence of the conducting particle usually does not affect the phase separation structure of the block copolymer (Z), an evaluation polymer electrolyte film may be prepared in the same manner as the electrode film except that the conducting particle is not included, and an ultrathin section for the TEM observation may be prepared therefrom, followed by observation of the presence or absence of the lamellar structure.

The width of the phase composed of the polymer block (S) in the lamellar structure is preferably within the range of 3 to 90 nm, more preferably within the range of 5 to 70 nm, still more preferably within the range of 7 to 40 nm. The “width of the phase” herein means the distance between the two phases adjacent to a specific phase forming the lamellar structure as shown in FIG. 1. Normally, the width L1 of each phase composed of the polymer block (S) is the same, and the width L2 of each phase composed of the polymer block (T) is the same. The sum of the width L1 of the phase composed of the polymer block (S) and the width L2 of the phase composed of the polymer block (T) is referred to as the cycle of the lamellar structure. The width of each phase can be measured by the above TEM observation for observing the presence or absence of the lamellar structure.

In cases where the width of the phase composed of the polymer block (S) is not less than 3 nm, the migration velocity of ions can be increased, and the response speed of the bend sensor can therefore be increased. On the other hand, in cases where the width of the phase composed of the polymer block (S) is not more than 90 nm, continuity of the lamellar structure can be increased, and the phases composed of the polymer block (S) can easily communicate between the main surfaces of the electrode films, so that the voltage generated between the electrode films of the bend sensor can be increased.

The block copolymer (Z) contained in the electrode films included in the bend sensor of the present invention is preferably obtained by producing a block copolymer (Z₀) having: a polymer block (S₀) composed of a structural unit derived from an aromatic vinyl compound, and containing no ion-conducting group (hereinafter simply referred to as “polymer block (S₀)”); and a polymer block (T); and then introducing an ion-conducting group(s) to the polymer block (S₀).

The number average molecular weight (Mn) of the block copolymer (Z₀) is preferably within the range of 5000 to 200,000, more preferably within the range of 20,000 to 150,000, still more preferably within the range of 30,000 to 130,000. In cases where Mn of the block copolymer (Z₀) is not less than 5000, phase separation is likely to occur in the block copolymer (Z) obtained, and the electrode film obtained tends to have excellent mechanical strength. On the other hand, in cases where Mn of the block copolymer (Z₀) is not more than 200,000, the block copolymer (Z) obtained tends to have excellent solubility in a solvent, which is advantageous in production of the bend sensor. In the present description, Mn represents a value obtained by measurement by gel permeation chromatography (GPC) (in terms of standard polystyrene).

The mass ratio between the polymer block (S₀) and the polymer block (T) (polymer block (S₀):polymer block (T)) in the block copolymer (Z₀) is preferably within the range of 40:60 to 90:10, more preferably within the range of 45:55 to 85:15, still more preferably within the range of 50:50 to 80:20. In cases where the ratio of the polymer block (S₀) in the block copolymer (Z₀) is not less than 40% by mass, the phase(s) composed of the polymer block (S) and the phase(s) composed of the polymer block (T) are likely to form a lamellar structure, and, in cases where the ratio is not more than 90% by mass, flexibility of the electrode film tends to be high.

Examples of the aromatic vinyl compound that can form the polymer block (S₀) include styrene, 2-methylstyrene, 3-methylstyrene, 4-methylstyrene, 4-ethylstyrene, 2,4-dimethylstyrene, 2,5-dimethylstyrene, 3,5-dimethylstyrene, 2-methoxystyrene, 3-methoxystyrene, 4-methoxystyrene, vinylbiphenyl, vinylterphenyl, vinylnaphthalene, vinylanthracene, and 4-phenoxystyrene.

The carbon at the α-position in the aromatic ring (α-carbon) in the aromatic vinyl compound may be a quaternary carbon. In cases where the α-carbon is a quaternary carbon, examples of a substituent linked to the α-carbon include alkyl groups having 1 to 4 carbon atoms, such as methyl, ethyl, n-propyl, isopropyl, n-butyl, isobutyl, sec-butyl, and tert-butyl; halogenated alkyl groups having 1 to 4 carbon atoms, such as chloromethyl, 2-chloroethyl, and 3-chloroethyl; and aryl groups such as phenyl. Preferred examples of aromatic vinyl compounds having these substituents include α-methylstyrene, α-methyl-4-methylstyrene, α-methyl-4-ethylstyrene, and 1,1-diphenylethylene.

From the viewpoint of introducing an ion-conducting group to an aromatic ring in the polymer block (S₀), the aromatic ring of the aromatic vinyl compound preferably does not have a functional group which inhibits the reaction for introducing the ion-conducting group. For example, since the introduction of the ion-conducting group may be difficult in cases where a hydrogen on the aromatic ring of the styrene (especially the hydrogen at 4-position) is substituted with an alkyl group (especially an alkyl group having not less than three carbon atoms) or the like, the aromatic ring is preferably not substituted with another functional group, or is preferably substituted with a substituent to which, by itself, the ion-conducting group can be introduced. From the viewpoint of easy introduction of the ion-conducting group, styrene, α-methylstyrene, 4-methylstyrene, 4-ethylstyrene, and vinylbiphenyl are preferred.

The content of the structural unit(s) derived from the aromatic vinyl compound in the polymer block (S₀) is preferably not less than 90% by mass, more preferably not less than 95% by mass, or may be 100% by mass, from the viewpoint of formation of the lamellar structure by the phase(s) composed of the polymer block (S) and the phase(s) composed of the polymer block (T) in the electrode film obtained. These aromatic vinyl compounds may be used individually, or two or more of these may be used in combination.

The polymer block (S₀) may also contain another structural unit derived from a compound other than aromatic vinyl compounds as long as the effect of the present invention is not deteriorated. Examples of the another compound include conjugated dienes such as butadiene, 1,3-pentadiene, isoprene, 1,3-hexadiene, 2,4-hexadiene, 2,3-dimethyl-1,3-butadiene, 2-ethyl-1,3-butadiene, and 1,3-heptadiene; alkenes such as ethylene, propylene, 1-butene, 2-butene, isobutene, 1-pentene, 2-pentene, 1-hexene, 2-hexene, 1-heptene, 2-heptene, 1-octene, and 2-octene; (meth)acrylates such as methyl (meth)acrylate, ethyl (meth)acrylate, and butyl (meth)acrylate; vinyl esters such as vinyl acetate, vinyl propionate, vinyl butyrate, and vinyl pivalate; and vinyl ethers such as methyl vinyl ether and isobutyl vinyl ether. The total content of the structural unit derived from the another compound is preferably not more than 10% by mass, more preferably not more than 5% by mass with respect to the amount of the polymer block (S₀). These other compounds may be used individually, or two or more of these may be used in combination.

The polymer block (S₀) can be produced by polymerizing, as monomers, the aromatic vinyl compound described above and, if necessary, the another compound which is an arbitrary component.

The polymer block (S) can be formed by introducing an ion-conducting group(s) to the polymer block (S₀).

The ratio of the ion-conducting group(s) to the structural unit(s) derived from the aromatic vinyl compound constituting the polymer block (S) (hereinafter referred to as “ion-conducting group introduction rate”) is preferably within the range of 5 to 100 mol %, more preferably within the range of 7 to 80 mol %, still more preferably within the range of 10 to 70 mol % from the viewpoint of ease of handling, solubility in a solvent, and ion conductivity.

Examples of the ion-conducting group(s) contained in the polymer block (S) include a sulfonic acid group, phosphoric acid group, and carboxylic acid group. A sulfonic acid group is preferred.

As the method for introducing the ion-conducting group(s) to the polymer block (S₀) to form the polymer block (S), a known method may be used. A method for introducing a sulfonic acid group(s) to the polymer block (S₀) is described below.

Normally, in cases where a sulfonic acid group(s) is/are introduced to the polymer block (S₀), the block copolymer (Z₀) is reacted (sulfonation reaction) with the later-mentioned sulfonating agent in the presence or absence of an organic solvent. Normally, in cases where an organic solvent is used, a solution or a suspension of the block copolymer (Z₀) is prepared, and the sulfonating agent is then added thereto to provide a mixture.

Examples of the sulfonating agent used for the sulfonation reaction include sulfonic acid; mixed systems of sulfonic acid and an aliphatic acid anhydride; chlorosulfonic acid; mixed systems of chlorosulfonic acid and trimethylsilyl chloride; sulfur trioxide; mixed systems of sulfur trioxide and triethyl phosphate; and aromatic organic sulfonic acids such as 2,4,6-trimethylbenzene sulfonic acid. Examples of the organic solvent that may be used for the sulfonation reaction include halogenated hydrocarbons such as methylene chloride; chain aliphatic hydrocarbons such as hexane; and cyclic aliphatic hydrocarbons such as cyclohexane.

The polymer block (T) is an amorphous polymer block composed of a structural unit derived from an unsaturated aliphatic hydrocarbon. The “amorphous” nature herein can be confirmed by measuring the dynamic visco-elasticity of the block copolymer (Z), and observing the absence of a change in the storage elastic modulus derived by crystalline olefin polymers.

The unsaturated aliphatic hydrocarbon that can form the polymer block (T) is not limited as long as it has a polymerizable carbon-carbon double bond. Examples of the unsaturated aliphatic hydrocarbon include alkenes such as ethylene, propylene, 1-butene, 2-butene, isobutene, 1-pentene, 2-pentene, 1-hexene, 2-hexene, 1-heptene, 2-heptene, 1-octene, and 2-octene; and conjugated dienes such as butadiene, 1,3-pentadiene, isoprene, 1,3-hexadiene, 2,4-hexadiene, 2,3-dimethyl-1,3-butadiene, 2-ethyl-1,3-butadiene, and 1,3-heptadiene. Isobutene and conjugated dienes are preferred. In cases where the unsaturated aliphatic hydrocarbon has a plurality of polymerizable carbon-carbon double bonds, any of these may be used for the polymerization. For example, in cases where the unsaturated aliphatic hydrocarbon is a conjugated diene, the bond may be 1,2-bond, 1,4-bond, or a mixture of these. The content of the structural unit(s) derived from the unsaturated aliphatic hydrocarbon in the polymer block (T) is preferably not less than 90% by mass, more preferably not less than 95% by mass, or may be 100% by mass, from the viewpoint of formation of the lamellar structure by the phase(s) composed of the polymer block (S) and the phase(s) composed of the polymer block (T) in the electrode film obtained. These unsaturated aliphatic hydrocarbons may be used individually, or two or more of these may be used in combination.

The polymer block (T) may also contain a structural unit derived from a compound other than unsaturated aliphatic hydrocarbons, as long as the effect of the present invention is not deteriorated. Examples of the another compound include aromatic vinyl compounds such as styrene and vinyl naphthalene; halogen-containing vinyl compounds such as vinyl chloride; vinyl esters such as vinyl acetate, vinyl propionate, vinyl butyrate, and vinyl pivalate; and vinyl ethers such as methylvinyl ether and isobutyl vinyl ether. The total content of the structural unit derived from the another compound is preferably not more than 10% by mass, more preferably not more than 5% by mass with respect to the polymer block (T). These other compounds may be used individually, or two or more of these may be used in combination.

The polymer block (T) can be formed by polymerizing, as monomers, the unsaturated aliphatic hydrocarbon described above and, if necessary, the another compound which is an arbitrary component.

In the production of the block copolymer (Z₀), the method of polymerization using monomers capable of forming the polymer block copolymer (S₀) or monomers capable of forming the polymer block copolymer (T) is appropriately selected from, for example, radical polymerization, anionic polymerization, cationic polymerization, and coordination polymerization, depending on the types and/or the molecular weights of the monomers, and/or the like. From the viewpoint of simple industrial production, radical polymerization, anionic polymerization, and cationic polymerization are preferred. From the viewpoint of the molecular weight, the molecular weight distribution, and the like, living radical polymerization, living anionic polymerization, and living cationic polymerization are more preferred.

In terms of specific examples of the method for producing the block copolymer (Z₀), examples of methods for producing an S₀-T-S₀ type (S₀ and T represent the polymer block (S₀) and the polymer block (T), respectively) block copolymer (Z₀) in which the polymer block (S₀) is formed with an aromatic vinyl compound, and the polymer block (T) is formed with a conjugated diene, by living anionic polymerization include:

(1) a method in which sequential polymerization is carried out with the aromatic vinyl compound, with the conjugated diene, and then with the aromatic vinyl compound, in a nonpolar solvent such as cyclohexane in the presence of an anionic polymerization initiator at a temperature of 20 to 100° C.;

(2) a method in which sequential polymerization is carried out with the aromatic vinyl compound and then with the conjugated diene, in a nonpolar solvent such as cyclohexane in the presence of an anionic polymerization initiator at a temperature of 20 to 100° C., followed by addition of a coupling agent such as phenyl benzoate, α,α′-dichloro-p-xylene, or the like; and

(3) a method in which polymerization is carried out with the aromatic vinyl compound at a concentration of 5 to 50% by mass in a nonpolar solvent such as cyclohexane using an organic lithium compound as an anionic polymerization initiator, in the presence of a polar compound at a concentration of 0.1 to 10% by mass at a temperature of −30 to 30, and the resulting living polymer is polymerized with the conjugated diene, followed by addition of a coupling agent such as phenyl benzoate.

In terms of other specific examples of the method for producing the block copolymer (Z₀), examples of methods for producing an S₀-T-S₀ type block copolymer (Z₀) in which the polymer block (S₀) is formed with an aromatic vinyl compound, and the polymer block (T) is formed with isobutene, by living cationic polymerization include a method in which cationic polymerization of isobutene is carried out in a mixed solvent of a halogenated hydrocarbon and a hydrocarbon at −78° C. using a bifunctional cationic polymerization initiator in the presence of a Lewis acid, and polymerization of the aromatic vinyl compound is then carried out (see Macromol. Chem., Macromol. Symp. 32, 119 (1990)).

In cases where a conjugated diene is used as the unsaturated aliphatic hydrocarbon for formation of the polymer block (T), unsaturated bonds usually remain after the polymerization. In cases where unsaturated bonds derived from the unsaturated aliphatic hydrocarbon remain after the polymerization, part or all of the unsaturated bonds may be converted to saturated bonds by a known hydrogenation reaction to provide the polymer block (T). The hydrogenation rate of unsaturated bonds is preferably not less than 50 mol %, more preferably not less than 80 mol %. The hydrogenation rate can be calculated by ¹H-NMR measurement.

The block copolymer (Z) has one or more of each of the polymer block (S) and the polymer block (T). In cases where the block copolymer (Z) has a plurality of polymer blocks (S), those polymer blocks (S) may have the same or different structures (in terms of, for example, the type of the constituting monomers, the polymerization degree, and the type and the introduction ratio of the ion-conducting group). In cases where the block copolymer (Z) has a plurality of polymer blocks (T), those polymer blocks (T) may have the same or different structures (in terms of, for example, the type of the constituting monomers, and the polymerization degree).

In terms of the sequence of the polymer block(s) (S) and the polymer block(s) (T) in the block copolymer (Z), examples of the block copolymer (Z) include S-T type diblock copolymers (S and T represent a polymer block (S) and a polymer block (T), respectively), S-T-S type triblock copolymers, and T-S-T type triblock copolymers. S-T-S type triblock copolymers are preferred. These block copolymers (Z) may be used individually, or a mixture of two or more of these may be used in combination.

The number of equivalents of ion-conducting groups (hereinafter referred to as “ion exchange capacity”) per unit mass of the block copolymer (Z) is preferably within the range of 0.1 to 5 mmol/g, more preferably within the range of 0.3 to 2.5 mmol/g, still more preferably within the range of 0.5 to 1.5 mmol/g. In cases where the ion exchange capacity is not less than 0.1 mmol/g, the phase(s) composed of the polymer block (S) and the phase(s) composed of the polymer block (T) are likely to form a lamellar structure in the electrode film obtained, and, in cases where the ion exchange capacity is not more than 5 mmol/g, productivity of the block copolymer (Z) is high.

Examples of the conducting particle contained in the electrode films included in the bend sensor of the present invention include particles composed of, for example, metals such as gold, silver, copper, platinum, aluminum, and nickel; metal oxides such as ruthenium oxide (RuO₂), titanium oxide (TiO₂), tin oxide (SnO₂), iridium dioxide (IrO₂), tantalum oxide (Ta₂O₅), and indium-tin composite oxide (ITO); metal sulfides such as zinc sulfide (ZnS); conductive carbons such as carbon black (e.g., Ketjenblack (registered trademark)) and carbon nanotubes; and conductive polymers such as polyacetylene, polypyrrole, and polythiophene. From the viewpoint of ease of handling, the conducting particle is preferably a conductive carbon. These may be used individually, or two or more of these may be used in combination.

The average primary particle size of the conducting particle is preferably 1 nm to 1 μm, more preferably 10 to 500 nm. The average primary particle size can be determined by averaging the primary particle sizes of the conducting particles observed under the electron microscope. In cases where the conducting particle is a non-spherical particle such as a carbon nanotube or a vapor-grown carbon fiber, the primary particle size means the short diameter.

On the interface between the block copolymer (Z) and the conducting particle contained in the electrode film, an electrical double layer is formed. In cases where the interface between the block copolymer (Z) and the conducting particle is abundant, the voltage generated between the electrode films upon elastic deformation of the sensor section tends to be high. From such a viewpoint, the ratio between the block copolymer (Z) and the conducting particles contained in the electrode film (block copolymer (Z):conducting particles) is preferably 2:1 to 15:1, more preferably 3:1 to 10:1 in terms of the mass ratio. In cases where the ratio of the conducting particles is lower than that corresponding to a ratio of 15:1, the voltage tends to be insufficient, while in cases where the ratio of the conducting particles is higher than that corresponding to a ratio of 2:1, flexibility of the electrode film tends to be low.

The electrode film included in the bend sensor of the present invention may also contain a component other than the block copolymer (Z) and the conducting particle, as long as the effect of the present invention is not deteriorated. Examples of the another compound include resins other than the block copolymer (Z), and softeners and stabilizers. The total content of the another component in the electrode film is preferably not more than 10% by mass, more preferably not more than 5% by mass. That is, the total content of the block copolymer (Z) and the conducting particles in the electrode film is preferably not less than 90% by mass, more preferably not less than 95% by mass, or may be 100% by mass.

Examples of the method for producing the electrode film include a method in which the conducting particles are added to a solution or a suspension prepared by mixing the block copolymer (Z) and, if necessary, the another component (resin, softener, stabilizer, and/or the like) with an appropriate organic solvent, to prepare a dispersion (hereinafter referred to as “electrode film-forming dispersion”), and the electrode film-forming dispersion is then cast on a substrate composed of glass or the like, or applied to the substrate using a coater, applicator, screen printer, or the like, followed by removal of the organic solvent.

Examples of the organic solvent to be used for the preparation of the electrode film-forming dispersion include halogenated hydrocarbons such as dichloromethane; aromatic hydrocarbons such as toluene, xylene, benzene, isopropylbenzene, diisopropylbenzene, 1,2,4-trimethylbenzene, 1,3,5-trimethylbenzene, and cumene; aliphatic hydrocarbons such as hexane, heptane, and cyclohexane; ethers such as tetrahydrofuran, ethylene glycol mono-2-ethylhexyl ether, ethylene glycol monobutyl ether, ethylene glycol mono-t-butyl ether, and ethylene glycol monobutyl ether acetate; alcohols such as methanol, ethanol, 1-propanol, 2-propanol, 1-butanol, 2-methyl-1-propanol, 1-hexanol, and ethylene glycol; and mixed solvents thereof. Mixed solvents of an aromatic hydrocarbon and an alcohol are preferred. The amount of the organic solvent used is not limited, and preferably within the range of 1 to 20 masses of the block copolymer (Z).

The conditions for the removal of the organic solvent are not limited as long as the block copolymer (Z) is not degraded. Examples of the removal method include a method in which hot air drying is carried out at a temperature within the range of 60 to 140° C.; a method in which drying is carried out at a temperature within the range of 10 to 30° C. under normal pressure, and hot air drying is then carried out at a temperature within the range of 60 to 140° C. (especially 80 to 120° C.); a method in which drying is carried out at a temperature within the range of 10 to 30° C. under normal pressure, and further drying is carried out at a temperature within the range of 25 to 40° C. under reduced pressure; and a method in which drying is carried out at a temperature within the range of 10 to 30° C. under normal pressure, and further drying is carried out at a temperature within the range of 60 to 140° C. (especially 80 to 120° C.) under normal pressure. From the viewpoint of the film-forming performance, a method in which drying is carried out at a temperature within the range of 10 to 30° C. under normal pressure, and further drying is carried out at a temperature within the range of 80 to 120° C. under normal pressure is preferred.

### [Polymer Electrolyte Film]

The thickness of the polymer electrolyte film included in the bend sensor of the present invention is preferably 1 μm to 10 mm, more preferably 5 μm to 1 mm, still more preferably 10 to 500 μm.

The polymer electrolyte film contains a polymer electrolyte. Examples of the polymer electrolyte include: aromatic condensation polymers such as sulfonated poly(4-phenoxybenzoyl-1,4-phenylene) and alkylsulfonated polybenzoimidazole; sulfone group-containing perfluorocarbons (for example, Nafion (registered trademark, manufactured by DuPont) and Aciplex (registered trademark, manufactured by Asahi Kasei Corporation)); carboxyl group-containing perfluorocarbons (for example, Flemion S membrane (registered trademark, manufactured by Asahi Glass Co., Ltd.)); and block copolymers (Z′) (hereinafter simply referred to as “block copolymers (Z′)”) having a polymer block (S′) composed of a structural unit derived from an aromatic vinyl compound, and containing an ion-conducting group (hereinafter simply referred to as “polymer block (S′)”, and an amorphous polymer block (T′) composed of a structural unit derived from an unsaturated aliphatic hydrocarbon (hereinafter simply referred to as “polymer block (T′)”). In particular, block copolymers (Z′) are preferred from the viewpoint of adhesiveness to the electrode film.

The polymer electrolyte film may also contain, as an arbitrary component, a component other than the polymer electrolyte as long as the effect of the present invention is not deteriorated. Examples of the another compound include resins, softeners, and stabilizers. The total content of the arbitrary component in the polymer electrolyte film is preferably not more than 10% by mass, more preferably not more than 5% by mass. That is, the total content of the polymer electrolyte in the polymer electrolyte film is preferably not less than 90% by mass, more preferably not less than 95% by mass, or may be 100% by mass.

Examples of the method for producing the polymer electrolyte film include a method in which a solution or a suspension of a polymer electrolyte prepared by mixing the polymer electrolyte and, if necessary, the another component (resin, softener, stabilizer, and/or the like) with an appropriate organic solvent is cast on a substrate composed of glass or the like, or applied to the substrate using a coater, applicator, screen printer, or the like, followed by removal of the organic solvent.

Alternatively, a polymer electrolyte may be molded by compression molding, roll molding, extrusion molding, injection molding, or the like to provide the polymer electrolyte film.

The block copolymer (Z′) used for the polymer electrolyte film is described below.

The block copolymer (Z′) is obtained by producing a block copolymer (Z₀′) having: a polymer block (S₀′) composed of a structural unit derived from an aromatic vinyl compound, and containing no ion-conducting group (hereinafter simply referred to as “polymer block (S₀′)”); and a polymer block (T′); and then introducing an ion-conducting group(s) to the polymer block (S₀′).

The monomers capable of forming the polymer block (S₀′) (the aromatic vinyl compound, and/or the another component which is an arbitrary component) are the same as those for the polymer block (S₀).

The monomers capable of forming the polymer block (T′) (the unsaturated aliphatic hydrocarbon, and/or the another component which is an arbitrary component) are the same as those for the polymer block (T). In cases where unsaturated bonds derived from the unsaturated aliphatic hydrocarbon remain after the polymerization, part or all of the unsaturated bonds may be converted to saturated bonds by a known hydrogenation reaction to provide the polymer block (T′). The preferred hydrogenation rate is the same as that for the polymer block (T).

The mass ratio between the polymer block (S₀′) and the polymer block (T′) in the block copolymer (Z₀′) is preferably within the range of 10:90 to 90:10. In cases where the ratio of the polymer block (S₀′) is 10 to 90% by mass, the bend sensor can have high flexibility.

Preferred Mn of the block copolymer (Z₀′) is the same as that for the block copolymer (Z₀).

Examples of the ion-conducting group to be introduced to the block copolymer (S₀′) and the preferred ion-conducting group introduction rate are the same as those for the block copolymer (S₀).

The block copolymer (Z′) used in the polymer electrolyte film may be the same as or different from the block copolymer (Z) contained in the electrode film.

The block copolymer (Z′) can be produced by the same method as the block copolymer (Z).

### [Collecting Electrode]

For reduction of the surface resistance of the electrode film, a collecting electrode having a higher electric conductivity than the electrode film may be provided on a surface (surface of the electrode film) of the sensor. The thickness of the collecting electrode is preferably within the range of 0.01 to 200 μm, more preferably within the range of 0.05 to 100 μm, still more preferably within the range of 0.1 to 20 μm. In cases where the thickness of the collecting electrode is not more than 0.01 μm, the film forming tends to be difficult, while in cases where the thickness exceeds 200 μm, flexibility of the collecting electrode tends to be low.

Examples of the collecting electrode include metal thin films of gold, silver, copper, platinum, aluminum, or the like; and film-shaped molded products composed of a conductive powder (for example, a metal powder (gold powder, silver powder, nickel powder, or the like) or a carbon powder (carbon powder, carbon nanotube, carbon fiber, or the like)) and a binder resin (for example, a polyester resin). Among these, from the viewpoint of the electric conductivity and the flexibility, film-shaped molded products composed of a metal powder and a binder resin are preferred.

Examples of the method for forming the collecting electrode on the surface of the electrode film include a method in which a metal thin film is formed on the collecting electrode by vacuum evaporation, sputtering, electroplating, chemical plating, or the like; a method in which a dispersion composed of a conductive powder, a binder resin, and a solvent is applied; and a method in which a collecting electrode separately prepared is attached by pressing or welding. Among these, from the viewpoint of the processability and the versatility, a method in which a dispersion composed of a conductive powder, a binder resin, and a solvent is applied is preferred.

### [Protective Film]

The bend sensor of the present invention may be provided with a protective film for physically protecting the sensor section. The protective film is preferably provided on the outermost surface of the bend sensor. The thickness of the protective film is preferably within the range of 5 to 350 μm, more preferably within the range of 7.5 to 300 μm, still more preferably within the range of 10 to 200 μm. In cases where the thickness of the protective film is less than 5 μm, the ease of handling may decrease, while in cases where the thickness is more than 350 μm, the flexibility of the bend sensor tends to be deteriorated.

The protective film is preferably a common polymer film, and examples of common polymer films that may be used include polyethylene terephthalate films, polyethylene naphthalate films, polyolefin films, polyurethane films, polyvinyl chloride films, and elastomer films.

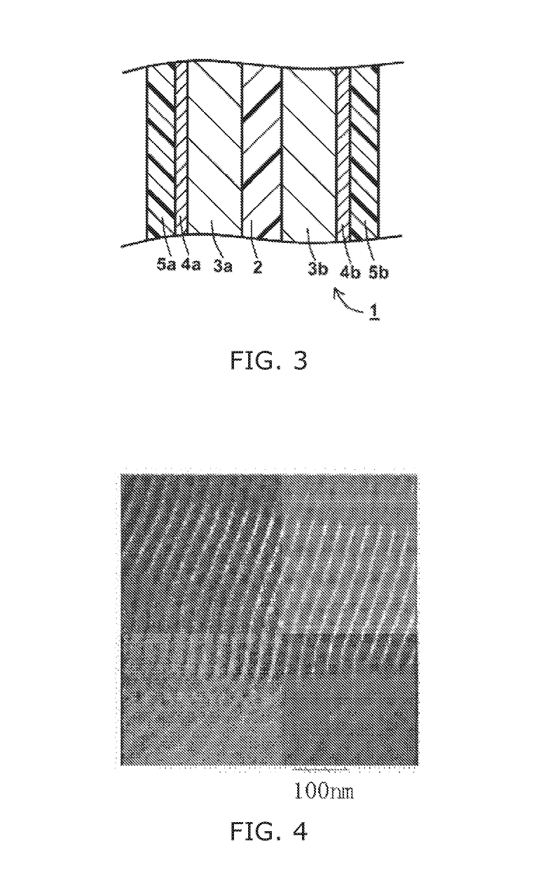

FIG. 3 shows an example of the cross-sectional structure of a bend sensor of the present invention in which a collecting electrode 4a and a collecting electrode 4b are provided on the surfaces of an electrode film 3a and an electrode film 3b, and a protective film 5a and a protective film 5b are further provided on the surfaces thereof.

Examples of the method for producing the bend sensor of the present invention include:

(i) a method in which an electrode film-forming dispersion is applied/dried on one side of a polymer electrolyte film to form an electrode film, thereby preparing a laminate of the polymer electrolyte film and the electrode film, followed by attaching two sheets of the laminate together by heat press or the like such that their polymer electrolyte film sides face each other to form a sensor section, and then, if necessary, forming collecting electrodes and/or protective films;

(ii) a method in which an electrode film-forming dispersion is applied/dried on both sides of a polymer electrolyte film to form electrode films, thereby preparing a sensor section, and then, if necessary, collecting electrodes and/or protective films are formed.

(iii) a method in which a collecting electrode is formed, if necessary, on a film which is a protective film, and an electrode film-forming dispersion is then applied/dried thereon to form an electrode film, followed by applying/drying a solution or a dispersion composed of a polymer electrolyte and an organic solvent thereon to form a polymer electrolyte film, further applying/drying an electrode film-forming dispersion thereon to form an electrode film, and then forming, if necessary, a collecting electrode and/or a protection layer; and

(iv) a method in which a collecting electrode is formed, if necessary, on a film which is a protective film, and an electrode film-forming dispersion is then applied/dried thereon to form an electrode film, followed by applying/drying a solution or a dispersion composed of a polymer electrolyte and an organic solvent thereon to form a polymer solid electrolyte film, and attaching two sheets of the obtained laminate together by heat press or the like such that their polymer electrolyte film sides face each other.

The bend sensor of the present invention can operate in air, in water, in vacuum, or in an organic solvent. Depending on the use environment, the sensor may be sealed. Examples of the sealing material include, but are not limited to, various resins.

### EXAMPLES

The present invention is described below more concretely by way of Production Examples, Examples, and Comparative Examples. However, the present invention is not limited by these.

The measurement methods that were carried out in the Production Examples, Examples, and Comparative Examples described below were as follows.

### [1] Content (Mass %) of Structural Units, Hydrogenation Ratio (Mol %), and Ion-Conducting Group Introduction Rate (Mol %) in Block Copolymer

The calculation was carried out based on a ¹H-NMR spectrum obtained by measurement using a nuclear magnetic resonance apparatus (manufactured by JEOL Ltd., JNM-LA400) with, as a solvent, deuterated chloroform or a mixture of deuterated tetrahydrofuran and deuterated methanol (mass ratio, 80:20).

### [2] Number Average Molecular Weight (Mn)

Mn of the polymer was measured using the following measurement device under the following conditions. Mn of the polymer was calculated by conversion using a calibration curve for standard polystyrene.

GPC system: HLC-8220GPC, manufactured by Tosoh Corporation

Columns: TSK guard Column Super MP-M;
TSK gel G3000H; and
TSK gel Super Multipore HZ-M;

These columns were linearly connected in this order, and used for the measurement under the following conditions.

Detector: RI detector

Column oven temperature: 40° C.

Eluent: tetrahydrofuran

Standard sample: polystyrene

### [3] Calculation of Ion Exchange Capacity

Each block copolymer (Z) obtained in the Production Examples described later was weighed (weighed value, a (g)), and dissolved in 100 masses of tetrahydrofuran. To this solution, an excess amount of saturated aqueous sodium chloride solution ((300 to 500)×a (ml)) was added, and the resulting mixture was stirred in a closed system for 12 hours. Using phenolphthalein as an indicator, hydrogen chloride generated in the water was subjected to neutralization titration (titration volume, b (ml)) using 0.01 N standard aqueous sodium hydroxide solution (titer, f). From the above results, the ion exchange capacity per 1 g of the block copolymer (Z) was calculated by the following equation.

Ion exchange capacity per 1 g of the block copolymer (Z) (mmol/g)=(0.01×b×f)/a

### [4] Evaluation of Amorphous Nature of Polymer Block (T)

A solution of the block copolymer (Z) obtained in each of the later-described Production Examples in toluene/isopropyl alcohol (mass ratio, 5/5) at a concentration of 20% by mass was prepared, and a mold-release-treated PET film [manufactured by Mitsubishi Plastics, Inc.; MRV (trade name)] was coated with the resulting solution to a thickness of about 350 μm. The coating was dried using a hot air dryer at 100° C. for 4 minutes, and then peeled off from the mold-release-treated PET film at 25° C., to obtain a polymer film having a thickness of 30 μm. The storage elastic modulus (E′), the loss elastic modulus (E″), and the loss tangent (tan δ) of the polymer film were measured using a wide-range dynamic viscoelasticity measuring device (“DVE-V4FT Rheospectrer”, manufactured by Rheology Co., Ltd.) under the following conditions: tension mode (frequency, 11 Hz); temperature increase from −80° C. to 250° C. at a heating rate of 3° C./minute. As a result, no change in the storage elastic modulus at 80 to 100° C., which is derived by crystalline polyolefin, was found in any of the block copolymers (Z). Accordingly, the polymer block (T) was judged to be amorphous.

### [5] Evaluation of Presence/Absence of Lamellar Structure

In 74.6 g of diisopropylbenzene/1-hexanol (mass ratio, 3/7), 20.8 g of the block copolymer (Z) obtained in each of the later-described Production Examples was dissolved to prepare a polymer electrolyte solution. On an elastomer (manufactured by Kuraray; Septon (registered trademark)) film, application of the polymer electrolyte solution and drying thereof at 80° C. were repeated using a screen printer, to form an evaluation polymer electrolyte film having a thickness of 100 μm. Subsequently, part of the evaluation polymer electrolyte film was collected, and embedded in an epoxy resin, followed by cutting the evaluation polymer electrolyte film using a razor blade along the thickness direction under a stereoscopic microscope to expose a cross section. The film was then immersed in 1 mol/L aqueous lead nitrate solution three nights to carry out staining. From the resulting sample, ultrathin sections were prepared by microtomy, and the sections were then observed using a TEM (manufactured by Hitachi, Ltd.; H7100FA) to judge the presence or absence of a lamellar structure. From the observation results, the presence of absence a lamellar structure in the electrode film prepared in each of the Examples and the Comparative Examples was judged.

### Production Example 1: Synthesis of Block Copolymer Composed of Polystyrene and Hydrogenated Polybutadiene (Z₀-1)

The materials used were sufficiently dehydrated in advance.

The atmosphere in a pressure vessel equipped with a stirrer was sufficiently replaced with nitrogen, and 300 g of styrene and 2200 g of cyclohexane were placed in the vessel, followed by starting stirring. To this mixture, 16.5 ml of sec-butyllithium (1.3 M, solution in cyclohexane, corresponding to 21.5 mmol) was added, and polymerization was carried out at 50° C. for 1 hour. Mn of the polymer (polystyrene) measured after sampling of this reaction liquid was 14,000. Subsequently, 5.4 g of tetrahydrofuran and 150 g of butadiene were added to the reaction liquid, and polymerization was carried out for 1 hour. Thereafter, 21.8 ml of α,α′-dichloro-p-xylene (0.5 M, solution in toluene) was added to the reaction liquid, and the resulting mixture was stirred at 60° C. for 1 hour to perform coupling reaction. Subsequently, the reaction liquid was poured into 7 L of stirred methanol, and the precipitated polymer was collected by filtration, followed by drying at 60° C. at 50 Pa to obtain 446 g of a polystyrene-polybutadiene-polystyrene type block copolymer (hereinafter referred to as SBS). Mn of the SBS was 55,000.

A solution of the obtained SBS in cyclohexane was prepared, and the solution was placed in a pressure vessel whose atmosphere was sufficiently replaced with nitrogen. Thereafter, hydrogenation reaction was carried out using a Ni/Al Ziegler-type hydrogenation catalyst under hydrogen atmosphere at 80° C. for 5 hours to obtain 445 g of a polystyrene-hydrogenated polybutadiene-polystyrene type block copolymer (Z₀) (hereinafter referred to as block copolymer (Z₀-1). In the obtained block copolymer (Z₀-1), the hydrogenation rate was 99.5 mol %; Mn was 55,100; and the content of styrene units was 67% by mass.

### Production Example 2: Synthesis of Block Copolymer (Z-1)

In a glass reaction vessel equipped with a stirrer, 50 g of the block copolymer (Z₀-1) obtained in Production Example 1 was dried under vacuum for 1 hour. After replacing the atmosphere with nitrogen, 1 L of methylene chloride was added, and the resulting mixture was stirred at 50° C. for 2 hours to allow dissolution. Thereafter, a sulfonating agent obtained by reacting 10.7 ml of acetic anhydride with 4.8 ml of sulfuric acid in 20.5 ml of methylene chloride at 0° C. was added dropwise to the resulting solution for 20 minutes. The resulting mixture was stirred at 50° C. for 3 hours, and the reaction liquid was then poured into 2 L of stirred distilled water to allow coagulation/precipitation of solids, followed by performing filtration. The obtained solids were added to 2 L of distilled water, and the resulting mixture was stirred (washed) for 30 minutes, followed by performing filtration. This operation of washing and filtration was repeated until no pH change was found in the filtrate, and the solids collected by the final filtration were dried at 25° C. at 50 Pa to obtain 53 g of a block copolymer (Z) (hereinafter referred to as block copolymer (Z-1)). The ion-conducting group introduction rate of the obtained block copolymer (Z-1) to styrene units was 18 mol % according to ¹H-NMR analysis, and the ion exchange capacity was 1.0 mmol/g.

Using the obtained block copolymer (Z-1), an evaluation polymer electrolyte film was prepared by the method described above, and the presence or absence of a lamellar structure was investigated. As a result, as shown in FIG. 4, phases composed of the polymer block (S) stained with lead nitrate could be observed in a dark color, and phases composed of the polymer block (T) could be observed in a light color, indicating formation of a lamellar structure. Thus, it could be judged that, also in the electrode film prepared in the later-mentioned Example 1, a lamellar structure was formed by phases composed of the polymer block (S) and phases composed of the polymer block (T). The width of the phase composed of the polymer block (S) was 17 nm.

### Production Example 3: Synthesis of Block Copolymer (Z₀-2) Composed of Poly(α-Methylstyrene) and Hydrogenated Polybutadiene

The materials used were sufficiently dehydrated in advance.

The atmosphere in a pressure vessel equipped with a stirrer was sufficiently replaced with nitrogen, and 172 g of α-methylstyrene, 251 g of cyclohexane, 47.3 g of methylcyclohexane, and 5.9 g of tetrahydrofuran were placed in the vessel, followed by starting stirring. The resulting mixture was cooled to −10° C., and 16.8 ml of sec-butyllithium (1.3 M, solution in cyclohexane, corresponding to 21.8 mmol) was added to the mixture, followed by performing polymerization for 5 hours. Mn of the polymer (poly(α-methylstyrene)) measured after sampling of this reaction liquid was 7100. Subsequently, 35.4 g of butadiene was added to the reaction liquid, and the resulting mixture was stirred for 30 minutes, followed by adding 1680 g of cyclohexane thereto. Subsequently, the temperature of the reaction liquid was increased to 60° C. for 30 minutes, and the reaction liquid was then stirred at 60° C. for 1.5 hours. When the temperature increase was started, addition of 310 g of butadiene was started. The addition was carried out for 1 hour. Thereafter, 21.8 ml of α,α′-dichloro-p-xylene (0.5 M, solution in toluene) was added to the reaction liquid, and the resulting mixture was stirred at 60° C. for 1 hour to perform coupling reaction. Subsequently, the reaction liquid was poured into 7 L of stirred methanol, and the precipitated polymer was collected by filtration, followed by drying at 60° C. at 50 Pa to obtain 506 g of a poly(α-methylstyrene)-polybutadiene-poly(α-methylstyrene) type block copolymer (hereinafter referred to as mSBmS). Mn of the mSBmS was 79,500.

A solution of the obtained mSBmS in cyclohexane was prepared, and the solution was placed in a pressure vessel whose atmosphere was sufficiently replaced with nitrogen. Thereafter, hydrogenation reaction was carried out using a Ni/Al Ziegler-type hydrogenation catalyst under hydrogen atmosphere at 80° C. for 5 hours to obtain 505 g of a poly(α-methylstyrene)-hydrogenated polybutadiene-poly(α-methylstyrene) type block copolymer (Z₀) (hereinafter referred to as block copolymer (Z₀-2)). In the obtained block copolymer (Z₀-2), the hydrogenation rate was 99.6 mol %; Mn was 79,600; and the content of α-methylstyrene units was 31% by mass.

### Production Example 4: Synthesis of Block Copolymer (Z-2)

In a glass reaction vessel equipped with a stirrer, 100 g of the block copolymer (Z₀-2) obtained in Production Example 3 was dried under vacuum for 1 hour. After replacing the atmosphere with nitrogen, 1 L of methylene chloride was added, and the resulting mixture was stirred at 35° C. for 2 hours to allow dissolution. Thereafter, a sulfonating agent obtained by reacting 21.0 ml of acetic anhydride with 9.34 ml of sulfuric acid in 41.8 ml of methylene chloride at 0° C. was added dropwise to the resulting solution for 20 minutes. The resulting mixture was stirred at 25° C. for 7 hours, and the reaction liquid was then poured into 2 L of stirred distilled water to allow coagulation/precipitation of solids, followed by performing filtration. The obtained solids were added to distilled water (2 L) at 90° C., and the resulting mixture was stirred (washed) for 30 minutes, followed by performing filtration. This operation of washing and filtration was repeated until no pH change was found in the filtrate, and the solids collected by the final filtration were dried at 25° C. at 50 Pa to obtain 106 g of a block copolymer (Z) (hereinafter referred to as block copolymer (Z-2)). The ion-conducting group introduction rate of the obtained block copolymer (Z-2) to α-methylstyrene units was 50 mol %, and the ion exchange capacity was 1.06 mmol/g.

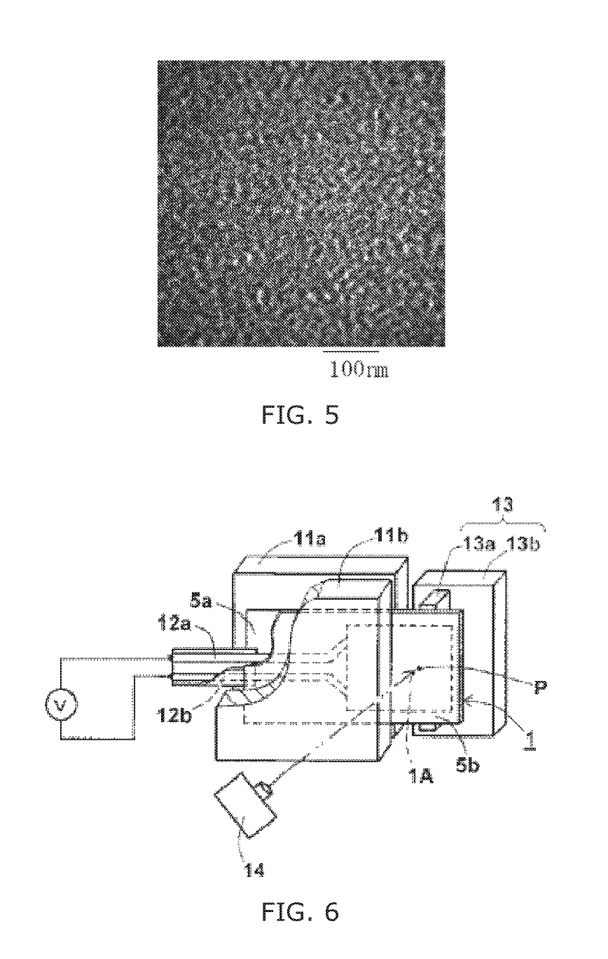

Using the obtained block copolymer (Z-2), an evaluation polymer electrolyte film was prepared by the method described above, and the presence or absence of a lamellar structure was investigated. As a result, as shown in FIG. 5, phases composed of the polymer block (S) stained with lead nitrate could be observed in a dark color, and phases composed of the polymer block (T) could be observed in a light color. However, formation of the lamellar structure could not be found. Thus, it was judged that, also in the electrode film prepared in the later-mentioned Comparative Example 1, a lamellar structure constituted by phases composed of the polymer block (S) and phases composed of the polymer block (T) was not formed.

### Production Example 5: Synthesis of Block Copolymer (Z₀-3) Composed of Poly(α-Methylstyrene) and Hydrogenated Polybutadiene

The materials used were sufficiently dehydrated in advance.

The atmosphere in a pressure vessel equipped with a stirrer was sufficiently replaced with nitrogen, and 300 g of α-methylstyrene, 438 g of cyclohexane, 82.5 g of methylcyclohexane, and 10.3 g of tetrahydrofuran were placed in the vessel, followed by starting stirring. The mixture was cooled to −10° C., and 9.9 ml of sec-butyllithium (1.3 M, solution in cyclohexane, corresponding to 12.9 mmol) was added thereto, followed by performing polymerization for 5 hours. Mn of the polymer (poly(α-methylstyrene)) measured after sampling of this reaction liquid was 21,000. Subsequently, 13 g of butadiene was added to the reaction liquid, and the resulting mixture was stirred for 30 minutes, followed by adding 1460 g of cyclohexane thereto. Subsequently, the temperature of the reaction liquid was increased to 60° C. for 30 minutes, and the reaction liquid was then stirred at 60° C. for 1.5 hours. When the temperature increase was started, addition of 120 g of butadiene was started. The addition was carried out for 1 hour. Thereafter, 12.9 ml of α,α′-dichloro-p-xylene (0.5 M, solution in toluene) was added to the reaction liquid, and the resulting mixture was stirred at 60° C. for 1 hour to perform coupling reaction. Subsequently, the reaction liquid was poured into 7 L of stirred methanol, and the precipitated polymer was collected by filtration, followed by drying at 60° C. at 50 Pa to obtain 405 g of a poly(α-methylstyrene)-polybutadiene-poly(α-methylstyrene) type block copolymer (hereinafter referred to as mSBmS). Mn of the mSBmS was 79,700.

A solution of the obtained mSBmS in cyclohexane was prepared, and the solution was placed in a pressure vessel whose atmosphere was sufficiently replaced with nitrogen. Thereafter, hydrogenation reaction was carried out using a Ni/Al Ziegler-type hydrogenation catalyst under hydrogen atmosphere at 80° C. for 5 hours to obtain 403 g of a poly(α-methylstyrene)-hydrogenated polybutadiene-poly(α-methylstyrene) type block copolymer (Z₀) (hereinafter referred to as block copolymer (Z₀-3). In the obtained block copolymer (Z₀-3), the hydrogenation rate was 99.6 mol %; Mn was 79,900; and the content of α-methylstyrene units was 67% by mass.

### Production Example 6: Synthesis of Block Copolymer (Z-3)

In a glass reaction vessel equipped with a stirrer, 100 g of the block copolymer (Z₀-3) obtained in Production Example 5 was dried under vacuum for 1 hour. After replacing the atmosphere with nitrogen, 1 L of methylene chloride was added, and the resulting mixture was stirred at 35° C. for 2 hours to allow dissolution. Thereafter, a sulfonating agent obtained by reacting 21.0 ml of acetic anhydride with 9.34 ml of sulfuric acid in 41.8 ml of methylene chloride at 0° C. was added dropwise to the resulting solution for 20 minutes. The resulting mixture was stirred at 25° C. for 7 hours, and the reaction liquid was then poured into 2 L of stirred distilled water to allow coagulation/precipitation of solids, followed by performing filtration. The obtained solids were added to distilled water (2 L) at 90° C., and the resulting mixture was stirred (washed) for 30 minutes, followed by performing filtration. This operation of washing and filtration was repeated until no pH change was found in the filtrate, and the solids collected by the final filtration were dried at 25° C. at 50 Pa to obtain 106 g of a block copolymer (Z) (hereinafter referred to as block copolymer (Z-3)). The ion-conducting group introduction rate of the obtained block copolymer (Z-3) to α-methylstyrene units was 18 mol %, and the ion exchange capacity was 1.06 mmol/g.

Using the obtained block copolymer (Z-3), an evaluation polymer electrolyte film was prepared by the method described above, and the presence or absence of a lamellar structure was investigated. As a result, phases composed of the polymer block (S) stained with lead nitrate could be observed in a dark color, and phases composed of the polymer block (T) could be observed in a light color, indicating formation of a lamellar structure. Thus, it could be judged that, also in the electrode film prepared in the later-mentioned Example 2, a lamellar structure was formed by phases composed of the polymer block (S) and phases composed of the polymer block (T). The width of the phase composed of the polymer block (S) was 19 nm.

### Production Example 7: Synthesis of Block Copolymer Composed of Polystyrene and Hydrogenated Polybutadiene (Z₀-4)

The materials used were sufficiently dehydrated in advance.

The atmosphere in a pressure vessel equipped with a stirrer was sufficiently replaced with nitrogen, and 150 g of styrene and 2200 g of cyclohexane were placed in the vessel, followed by starting stirring. To this mixture, 20.6 ml of sec-butyllithium (1.3 M, solution in cyclohexane, corresponding 15 to 26.8 mmol) was added, and polymerization was carried out at 50° C. for 1 hour. Mn of the polymer (polystyrene) measured after sampling of this reaction liquid was 5600. Subsequently, 5.4 g of tetrahydrofuran and 334 g of butadiene were added to the reaction liquid, and polymerization was carried out for 1 hour. Thereafter, 26.8 ml of α,α′-dichloro-p-xylene (0.5 M, solution in toluene) was added to the reaction liquid, and the resulting mixture was stirred at 60° C. for 1 hour to perform coupling reaction. Subsequently, the reaction liquid was poured into 7 L of stirred methanol, and the precipitated polymer was collected by filtration, followed by drying at 60° C. at 50 Pa to obtain 482 g of a polystyrene-polybutadiene-polystyrene type block copolymer (hereinafter referred to as SBS). Mn of the SBS was 55,900.

A solution of the obtained SBS in cyclohexane was prepared, and the solution was placed in a pressure vessel whose atmosphere was sufficiently replaced with nitrogen. Thereafter, hydrogenation reaction was carried out using a Ni/Al Ziegler 31-type hydrogenation catalyst under hydrogen atmosphere at 80° C. for 5 hours to obtain 480 g of a polystyrene-hydrogenated polybutadiene-polystyrene type block copolymer (Z₀) (hereinafter referred to as block copolymer (Z₀-4)). In the obtained block copolymer (Z₀-4), the hydrogenation rate was 99.5 mol %; Mn was 56,000; and the content of styrene units was 31% by mass.

### Production Example 8: Synthesis of Block Copolymer (Z-4)

In a glass reaction vessel equipped with a stirrer, 50 g of the block copolymer (Z₀-4) obtained in Production Example 7 was dried under vacuum for 1 hour. After replacing the atmosphere with nitrogen, 1 L of methylene chloride was added, and the resulting mixture was stirred at 50° C. for 2 hours to allow dissolution. Thereafter, a sulfonating agent obtained by reacting 10.7 ml of acetic anhydride with 4.8 ml of sulfuric acid in 20.5 ml of methylene chloride at 0° C. was added dropwise to the resulting solution for 20 minutes. The resulting mixture was stirred at 50° C. for 3 hours, and the reaction liquid was then poured into 2 L of stirred distilled water to allow coagulation/precipitation of solids, followed by performing filtration. The obtained solids were added to 2 L of distilled water, and the resulting mixture was stirred (washed) for 30 minutes, followed by performing filtration. This operation of washing and filtration was repeated until no pH change was found in the filtrate, and the solids collected by the final filtration were dried at 25° C. at 50 Pa to obtain 53 g of a block copolymer (Z) (hereinafter referred to as block copolymer (Z-4)). The ion-conducting group introduction rate of the obtained block copolymer (Z-4) to styrene units was 50 mol % according to ¹H-NMR analysis, and the ion exchange capacity was 1.0 mmol/g.

Using the obtained block copolymer (Z-4), an evaluation polymer electrolyte film was prepared by the method described above, and the presence or absence of a lamellar structure was investigated. As a result, phases composed of the polymer block (S) stained with lead nitrate could be observed in a dark color, and phases composed of the polymer block (T) could be observed in a light color. However, formation of the lamellar structure could not be found. Thus, it was judged that, also in the electrode film prepared in the later-mentioned Comparative Example 2, a lamellar structure constituted by phases composed of the polymer block (S) and phases composed of the polymer block (T) was not formed.

### Example 1

In 74.6 g of a mixed solvent of diisopropylbenzene/1-hexanol (mass ratio, 3/7), 20.8 g of the block copolymer (Z-1) obtained in Production Example 2 was dissolved, and 4.6 g of a conductive carbon black (manufactured by Lion Corporation; Ketjenblack EC600JD; primary particle size, 34 nm) was added to the resulting solution, followed by mixing the resulting mixture using a homogenizer to prepare an electrode film-forming dispersion.

In 74 g of a mixed solvent of diisopropylbenzene/1-hexanol (mass ratio, 8/2), 26 g of the block copolymer (Z-2) obtained in Production Example 4 was dissolved to prepare a polymer electrolyte solution.

A commercially available silver paste (manufactured by 20 Fujikura Kasei Co., Ltd., DOTITE XA-954) was applied to a surface of an elastomer (manufactured by Kuraray Co., Ltd.; SEPTON (registered trademark)) protective film (25 mm length×35 mm width×200 μm thickness) using a screen printer, to form a collecting electrode layer (10 μm thickness). Subsequently, application, and drying at 80° C. of the electrode film-forming dispersion on the collecting electrode were repeated using a screen printer to form an electrode film (20 mm length×20 mm width×100 μm thickness).

Subsequently, application, and drying at 100° C. of the polymer electrolyte solution on the electrode film formed were repeated using a screen printer to form a polymer electrolyte film (20 mm length×20 mm width×15 μm thickness), thereby obtaining a conjugate in which the protective film, the collecting electrode, the electrode film, and the polymer electrolyte film were laminated on each other in this order. Two sheets of the obtained conjugate were stacked on each other such that their polymer electrolyte films faced each other, and then attached to each other by pressing at 100° C. at 0.5 MPa for 5 minutes, thereby producing a bend sensor of the present invention having a sensor section of 20 mm length×20 mm width.

### Comparative Example 1

A bend sensor was produced by the same operation as in Example 1 except that the block copolymer (Z-2) was used instead of the block copolymer (Z-1) for the electrode film-forming dispersion.

### Example 2

A bend sensor was produced by the same operation as in Example 1 except that the block copolymer (Z-3) was used instead of the block copolymer (Z-1) for the electrode film-forming dispersion.

### Comparative Example 2

A bend sensor was produced by the same operation as in Example 1 except that the block copolymer (Z-4) was used instead of the block copolymer (Z-1) for the electrode film-forming dispersion.

### (Evaluation of Performances of Bend Sensors)

The performances of the bend sensors produced in the Examples and the Comparative Examples were evaluated by measuring the voltage that was generated when each bend sensor underwent a predetermined level of elastic deformation.

FIG. 6 shows the measurement method. For the bend sensor 1 obtained in each of Example 1 and Comparative Example 1, collecting electrodes 4a and 4b were connected to a voltmeter (manufactured by Keyence Corporation; NR-ST04) through lead wires 12a and 12b, respectively. Half (20 mm length×10 mm width) of the sensor section 1A (20 mm length×20 mm width) was fixed using clamps 11a and 11b. Subsequently, 1 mm of displacement was given to the position 5 mm distant from the end of the sensor section 1A fixed by the clamps, from a diaphragm 13b of a displacement generator 13 through a drive transmission member 13a. The voltage generated upon the elastic deformation of the sensor section was measured using a data logger. The displacement of the sensor section 1A was measured using a laser displacement meter. The displacement was canceled 20 seconds after the beginning of the displacement.

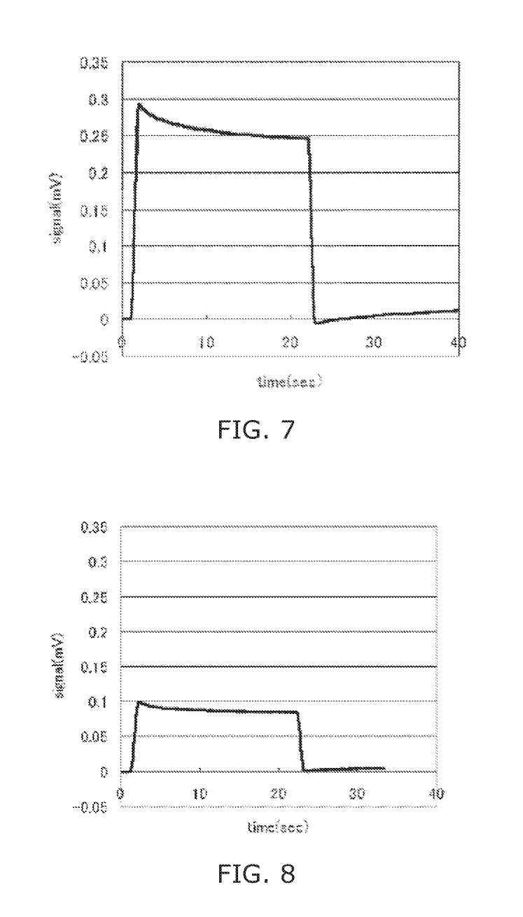

Changes in the voltage signal during the period before the cancellation of the displacement of the sensor section 1A were as shown in FIGS. 7 and 8, wherein FIG. 7 shows the result obtained using the bend sensor produced in Example 1, and FIG. 8 shows the result obtained using the bend sensor produced in Comparative Example 1. The maximum value of the voltage signal observed upon the elastic deformation of each bend sensor was 0.29 mV in Example 1, 0.28 mV in Example 2, 0.1 mV in Comparative Example 1, and 0.09 mV Comparative Example 2. As is evident from these results, it can be seen that the bend sensors obtained in Examples generate about three times higher voltages than the bend sensors obtained in Comparative Examples.

### INDUSTRIAL APPLICABILITY

In the bend sensor of the present invention, the voltage generated between the electrode films when the sensor section undergoes elastic deformation as it follows movement of an object is high, so that the measured values are reliable, and the sensor can be applied to a wide range of uses.

### DESCRIPTION OF SYMBOLS

1: Bend sensor
1A: Sensor section
2: Polymer electrolyte film
3a, 3b: Electrode film
4a, 4b: Collecting electrode
5a, 5b: Protective film
11a, 11b: Clip
12a, 12b: Lead wire
13: Displacement generator
13a: Drive transmission member
13b: Diaphragm
14: Laser displacement meter
L1: Width of the phase composed of the polymer block (S)
L2: Width of the phase composed of the polymer block (T)
P: Point of measurement of displacement

1. A bend sensor comprising a sensor section in which a polymer electrolyte film is sandwiched between a pair of electrode films each containing:
a block copolymer (Z) having:
a polymer block (S) composed of a structural unit derived from an aromatic vinyl compound, and containing an ion-conducting group; and
an amorphous polymer block (T) composed of a structural unit derived from an unsaturated aliphatic hydrocarbon; and
a conducting particle;
and having a lamellar structure formed by a phase composed of said polymer block (S) and a phase composed of said polymer block (T).

2. The bend sensor according to claim 1, wherein the width of said phase composed of said polymer block (S) forming said lamellar structure is within the range of 3 to 90 nm.

3. The bend sensor according to claim 1, wherein said block copolymer (Z) has a structure in which an ion-conducting group is introduced to a polymer block (S₀) of a block copolymer (Z₀) having:
a polymer block (S₀) composed of a structural unit derived from an aromatic vinyl compound, and containing no ion-conducting group; and
an amorphous polymer block (T) composed of a structural unit derived from an unsaturated aliphatic hydrocarbon;
wherein the mass ratio between said polymer block (S₀) and said polymer block (T) in said block copolymer (Z₀) is within the range of 40:60 to 90:10.
